(19) United States
(12) Patent Application Publication
(10) Pub. No.: US 2015/0115203 A1
(43) Pub. Date: Apr. 30, 2015

(54) PROCESS AND APPARATUS FOR THE PARALLEL PRODUCTION OF DIFFERENT SYNTHESIS GASES

(71) Applicant: LINDE AKTIENGESELLSCHAFT, Muenchen (DE)

(72) Inventors: Josef SCHWARZHUBER, Wolnzach (DE); Klemens WAWRZINEK, Muenchen (DE)

(73) Assignee: LINDE AKTIENGESELLSCHAFT, Muenchen (DE)

(21) Appl. No.: 14/529,645

(22) Filed: Oct. 31, 2014

(30) Foreign Application Priority Data
Oct. 31, 2013 (DE) 102013018330.8

(51) Int. Cl. C01B 3/38; B01J 19/24

(52) U.S. Cl. CPC C01B 3/382; B01J 19/248; C01B 2203/0233; C01B 2203/0816; C01B 2203/141; B01J 2219/2401
USPC 252/373; 422/606

(57) ABSTRACT

The invention relates to a process and an apparatus for the parallel production of at least two synthesis gases (10, 11) having different compositions from a hydrocarbon-containing starting material (1) which is, after mixing with steam (2) and/or carbon dioxide (3), fed to a steam reformer (R) and there converted into synthesis gas by steam reforming in at least two catalyst tubes (K1, K2, K3) operated in parallel. It is characteristic of the invention that at least two mixtures (6, 9) having different compositions are formed from the hydrocarbon-containing starting material (1) by division and addition of steam (2) and/or carbon dioxide (3), where each of the different mixtures (6, 9) is fed as exclusive feed to a catalyst tube or a group of catalyst tubes (K1, K2, K3) of the steam reformer (R) and converted into synthesis gas (10, 11).

The invention relates to a process for the parallel production of at least two synthesis gases having different compositions from a hydrocarbon-containing starting material which is, after mixing with steam and/or carbon dioxide, fed to a steam reformer and there converted into synthesis gas by steam reforming in at least two catalyst tubes operated in parallel.

The invention further provides an apparatus for carrying out the process.

Steam reforming has been used for many years to obtain hydrogen and/or carbon monoxide from hydrocarbon-containing starting materials. The hydrocarbon-containing starting materials, which are, for example, natural gas, naphtha, liquefied petroleum gas, or a hydrogen-rich gas such as a refinery gas, are firstly desulfurized and subsequently mixed with process steam and/or carbon dioxide before being fed, after preheating, to a steam reformer and converted there in an endothermic reaction with the aid of a catalyst into synthesis gas, viz. a gas mixture containing hydrogen and carbon monoxide together with at least carbon dioxide. In subsequent process steps, gas products such as hydrogen, carbon monoxide, carbon dioxide or mixtures of these gases are produced from the synthesis gas.

Steam reformers for industrial use are usually configured as tube ovens. They consist of a steel jacket which is provided with a refractory inner lining which encloses a firing chamber for the purpose of thermal insulation. A plurality of tubes (known as catalyst tubes) whose inner surfaces are catalytically active or are entirely or at least partly filled in the region of the firing chamber with a bed composed of a suitable catalyst material or a catalytically active structured packing are arranged parallel to one another in the firing chamber. The hydrocarbon-containing starting materials which have been mixed with steam and/or carbon dioxide are preheated and distributed over the catalyst tubes where they are converted into synthesis gas in an endothermic reforming reaction. The energy required for the reforming reaction is usually provided via burners which discharge their hot flue gas into the firing chamber. Part of the heat present in the flue gas is transferred by radiation and convection to the catalyst tubes, so that the gas has been cooled but is still hot when it goes from the firing chamber into the downstream waste heat system of the steam reformer. Further heat is withdrawn from the flue gas by means of heat exchangers which are arranged here and, for example, is utilized for preheating the starting materials or for generating process steam, so that it can finally be discharged at a temperature of only about 120-200° C. from the plant via a chimney.

Depending on whether the production of hydrogen or carbon dioxide is the main objective, a synthesis gas having a high or low ratio of hydrogen to carbon monoxide (H₂/CO ratio) is sought. This ratio depends first and foremost on the type of hydrocarbon-containing starting materials and also the amounts of water and/or carbon dioxide mixed in before reforming.

If a plurality of products are to be obtained from one starting material, it is usually not possible to design the individual production plants so that all products are produced under optimal conditions from the synthesis gas produced in a steam reformer. The production plant is therefore frequently designed such that only one main product can be produced with maximum efficiency while the other products are obtained under suboptimal conditions. For example, if hydrogen and carbon monoxide are to be produced as products but obtaining hydrogen is the main objective, a synthesis gas having a high H₂/CO ratio is produced from the starting material. In this case, the production apparatus used for separating off carbon monoxide cannot be operated optimally since it has to be designed for the total amount of hydrogen and carbon monoxide, which is substantially greater than the amount of carbon monoxide alone.

To circumvent this disadvantage, a plurality of production plants which are each optimized for obtaining different products are often operated in parallel in the prior art. For this purpose, the production plants are each designed with a dedicated steam reformer which provides a synthesis gas having an H₂/CO ratio which is matched to the product to be produced. This is achieved, for example, by process steam and carbon dioxide being mixed in each case in different ratios into the feeds to the individual steam reformers. Although such a configuration enables the flexibility of the overall plant to be improved, the capital costs and also, especially due to greater heat losses, the operating costs are increased.

It is therefore an object of the present invention to provide a process of the type described at the outset and also an apparatus for carrying it out, which make it possible to overcome the disadvantages of the prior art.

Upon further study of the specification and appended claims, other objects, aspects and advantages of the invention will become apparent.

According to the invention, these objects are achieved in terms of the process by at least two mixtures having different compositions being formed from the hydrocarbon-containing starting material by division and addition of steam and/or carbon dioxide, where each of the different mixtures is fed as exclusive feed to a catalyst tube or a group of catalyst tubes of the steam reformer and converted into a synthesis gas.

It is useful for a synthesis gas produced from a feed in a catalyst tube or a group of catalyst tubes to be treated further independently of the other synthesis gas(es) produced in one or more other catalyst tubes of the steam reformer from one or more feeds having a different composition. When a feed is converted into synthesis gas in a group of catalyst tubes, preference is given to all product streams from the catalyst tubes of this group being combined to give a synthesis gas stream and subsequently treated further.

The further treatment of a synthesis gas stream can be carried out fully independently of each further synthesis gas stream produced according to the invention. However, it is also possible for a treatment apparatus or a part of a treatment apparatus to be utilized jointly in the further treatment of two or more synthesis gas streams, or for a substream separated off from a synthesis gas stream to be mixed fully or in part with another synthesis gas stream in the further treatment. For example, two or more of the synthesis gas streams can each be treated independently by scrubbing with the same scrubbing medium (e.g. MDEA), with the scrubbing medium streams loaded in the scrubbing of the gas being fed for regeneration to a jointly utilized regeneration apparatus. Preference is given to adding a hydrogen-rich substream separated off from a synthesis gas stream to another synthesis gas stream from which a hydrogen product is produced by further treatment, e.g. by pressure swing adsorption.

In a preferred variant of the process of the invention, the hydrocarbon-containing starting material is split into precisely two parts, with only steam being mixed into one part and both steam and carbon dioxide being mixed into the other part in order to obtain a hydrogen-rich synthesis gas and a carbon monoxide-rich synthesis gas. While the hydrogen-rich synthesis gas is subsequently fed to a production apparatus optimized for obtaining hydrogen, the carbon monoxide-rich synthesis gas is processed further in a production apparatus which is optimized for obtaining carbon monoxide.

The catalyst tubes are advantageously operated at different outlet pressures as a function of the H₂/CO ratio of the synthesis gas produced therein. Decreasing outlet pressure favors hydrogen formation, so that those catalyst tubes in which a synthesis gas intended for hydrogen production is obtained are operated at a lower outlet pressure than catalyst tubes in which a synthesis gas intended for obtaining carbon monoxide is produced. Generally, the outlet pressure for both sets of catalyst tubes is within the range of about 10-60 bar, and the difference in outlet pressure between the tubes intended for hydrogen production and the tubes intended for obtaining carbon monoxide is, for example, 0.5-5 bar.

Carbon dioxide obtained in the further processing of the synthesis gases produced in the steam reformer is preferably used to form the feeds for the steam reformer. For this purpose, carbon dioxide already present in the synthesis gases or produced in the further processing thereof, for example by means of a water gas shift reaction, is separated off and recirculated to upstream of the steam reformer where it is optionally supplemented with imported carbon dioxide and mixed into one or more of the substreams formed from the starting material.

The invention further provides an apparatus for the parallel production of at least two synthesis gases having different compositions from a hydrocarbon-containing starting material, which comprises a steam reformer having a firing chamber and at least a first catalyst tube and a second catalyst tube and also a device (hereinafter referred to as mixing system) for mixing of steam and/or carbon dioxide into the hydrocarbon-containing starting material which is connected to the catalyst tubes.

According to the invention, the above-mentioned objects are achieved in terms of an apparatus by at least two mixtures having different compositions, of which each can be fed as exclusive feed to a catalyst tube or a group of catalyst tubes of the steam reformer, being producible from the starting material in the mixing system.

Preference is given to all catalyst tubes of the steam reformer being structurally identical and being arranged in the same firing chamber. However, the steam reformer having catalyst tubes which differ in respect of their dimensions and/or their structure and/or the type and/or amount of the catalyst material present therein or the catalyst tubes being arranged in more than one firing chamber is not to be ruled out.

The mixing system is preferably connected via a distributor to the entry ends of a plurality of catalyst tubes so that a mixture produced in the mixing system can be distributed as exclusive feed over a group of catalyst tubes. The catalyst tubes connected via a distributor to the mixing system can be arranged in any desired way in the firing chamber or chambers of the steam reformer. However, they are preferably arranged in one or more preferably parallel and adjacent rows of tubes. The arrangement of the catalyst tubes in rows of tubes results in substantial mechanical decoupling of catalyst tubes which are connected via different distributors to the mixing system.

In a particularly preferred embodiment of the apparatus of the invention, the outlet ends of all catalyst tubes connected to one another via a particular distributor are connected to one another via a collector via which exclusively the synthesis gas which is producible in these catalyst tubes can be collected and discharged. A pipe which connects the steam reformer to a downstream production apparatus and via which the synthesis gas produced in the catalyst tubes connected to one another via the collector can be fed independently of synthesis gas produced in other catalyst tubes of the steam reformer is advantageously connected to the collector.

The invention makes it possible to use only a single steam reformer to obtain a plurality of synthesis gases of different compositions in parallel. Significant plant components such as the waste heat system, the firing system and the safety system of the steam reformer do not therefore have to be replicated as in the prior art, as a result of which in particular the capital costs incurred for a plant for the parallel production of a plurality of synthesis gas products are significantly reduced. However, the operating costs are also reduced since there are lower heat losses and the hydrocarbon-containing starting material can be converted to a greater extent because of the process-optimized mode of operation.

### BRIEF DESCRIPTION OF THE DRAWINGS

The invention is illustrated in more detail below with the aid of two exemplary embodiments shown schematically in FIGS. 1 and 2.

FIG. 1 shows an apparatus for the parallel production of hydrogen and carbon monoxide, in which a mixing system and a steam reformer are utilized in order to produce two synthesis gases having different compositions from a hydrocarbon-containing starting material.

FIG. 2 shows an alternative configuration of a mixing system for producing two mixtures having different compositions as feeds for the steam reformer.

A hydrocarbon-containing starting material, for example desulfurized natural gas, is fed via line 1 to the mixing system M into which process steam 2 and carbon dioxide 3 are likewise introduced. Addition of process steam 2 produces the stream 4 from the hydrocarbon-containing starting material 1 and this stream 4 is subsequently heated in the first heat exchanger SH1 arranged in the waste heat system A of the steam reformer R and leaves the heat exchanger as stream 5 having a first temperature T1. Downstream of the heat exchanger SH1, the stream 5 which has been heated to the first temperature T1 is divided into a first, largely carbon dioxide-free feed 6 and a stream 7 from which the second, carbon dioxide-containing feed 8 is produced by addition of carbon dioxide 3. While the first feed 6 is fed via the distributor V1 into the catalyst tubes K1 and K2 arranged in two parallel rows D1 and D2 of tubes in the firing chamber F of the steam reformer R, the second feed 8 is heated to a second temperature T2 in the second heat exchanger SH2 which is likewise arranged in the waste heat system A of the steam reformer R. Generally, T1 and T2 are within the range of about 350° C.-700° C., and the difference between T2 and T1 is, for example, 0-150K. The heated second feed 9 is subsequently distributed via the second distributor V2 over the catalyst tubes K3 which are arranged in a third row D3 of tubes parallel to the rows D1 and D2 of tubes and are likewise located in the firing chamber F of the steam reformer R. In the catalyst tubes of the three rows D1, D2 and D3 of tubes, the two different feeds 6 and 9 are reacted with the aid of catalysts in endothermic reforming reactions, so that a hydrogen-rich synthesis gas 10 can be taken off from the steam reformer R via the collector S1 and a carbon monoxide-rich synthesis gas 11 can be taken off via the collector S2.

The energy required for the reforming reactions is provided by means of burners B which discharge their hot flue gases into the firing chamber F. Part of the heat present in the flue gases is transferred by radiation and convection to the catalyst tubes (K1, K2, K3), so that the flue gases are cooled but still hot when they go from the firing chamber F into the downstream waste heat system A of the steam reformer R. Further heat is withdrawn from the flue gases via the heat exchangers SH1 and SH2 arranged here and the flue gas coolers E before they leave the plant as offgas stream 12 via the chimney K.

The hydrogen-rich synthesis gas 10 is subsequently treated in a first production apparatus P1 optimized for the production of hydrogen in order to obtain one or more hydrogen products 13. The production apparatus P1 consists essentially of the sections synthesis gas cooling and carbon monoxide shift in which carbon monoxide is converted into hydrogen and carbon dioxide by reaction with steam in the water gas shift reaction. If carbon dioxide 14 is to be obtained as product, an apparatus for carbon dioxide removal, e.g. an amine scrub, can be arranged upstream of the final hydrogen purification which is, for example, carried out by means of pressure swing adsorption.

In a second production apparatus P2 optimized for producing carbon monoxide, carbon dioxide 15 is also produced in addition to one or more carbon monoxide products 16 from the carbon monoxide-rich synthesis gas 11. The production plant P2 consists in principle of the sections synthesis gas cooling, an apparatus for separating off carbon dioxide, a drier station and a cryogenic separation device or a membrane for obtaining the carbon monoxide product(s) 16.

To increase the amount of hydrogen product, hydrogen-rich gas obtained in the production apparatus P2 is transferred via line 19 into the production apparatus P1 and processed together with the hydrogen-rich synthesis gas 10. From the two carbon dioxide streams 14 and 15, a carbon dioxide stream 17 is formed and, after supplementation with carbon dioxide 18 imported from outside the confines of the plant, is supplied via line 3 to the mixing system M.

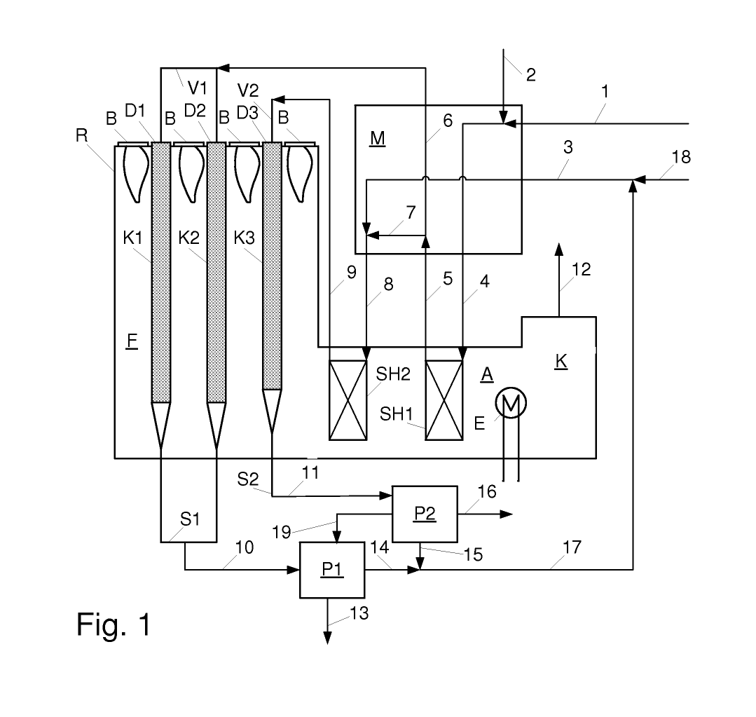

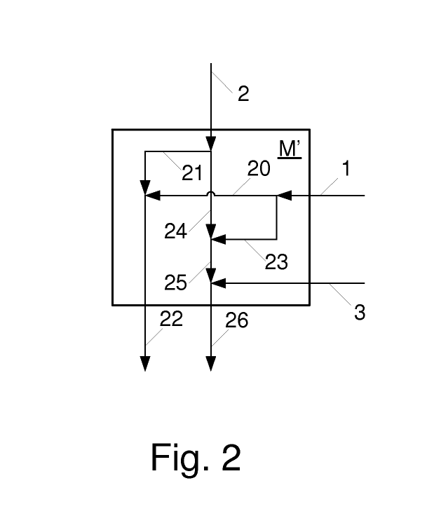

In FIG. 2, a hydrocarbon-containing starting material, for example desulfurized natural gas, is fed via line 1 into the mixing system M′ into which process steam 2 and carbon dioxide 3 are likewise introduced. A largely carbon dioxide-free feed 22 for the steam reformer R is produced from a first substream 20 of the hydrocarbon-containing starting material 1 by addition of a first substream 21 of the process steam 2 and this feed is subsequently heated in the heat exchanger SH1 and fed into the catalyst tubes K1 and K2 arranged in the rows D1 and D2 of tubes. Mixing of a second substream 23 of the hydrocarbon-containing starting material 1 with a second substream 24 of the process steam 2 forms the stream 25 from which a water- and carbon dioxide-containing feed 26 for the steam reformer R is produced by addition of carbon dioxide 3 and this feed 26 is subsequently heated in the second heat exchanger SH2 and fed into the catalyst tubes K3 arranged in the row D3 of tubes. Compared to the mixing system M shown in FIG. 1, the mixing system M′ makes a greater spread of the CO/H₂ ratios of the synthesis gases produced in the reformer R and also increased operational flexibility possible.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

The entire disclosures of all applications, patents and publications, cited herein and of corresponding German patent application DE 10 201 3 018 330.8, filed Oct. 31, 2013, are incorporated by reference herein.

1. A process for the parallel production of at least two synthesis gases (10, 11) having different compositions from a hydrocarbon-containing starting material (1), comprising:
dividing a stream of hydrocarbon-containing starting material (1) into at least two feed substreams and then forming, by addition of steam (2) and/or carbon dioxide (3), at least two feed mixtures (6, 9) having different compositions, and
feeding each of said at least two feed mixtures (6, 9) as exclusive feed to a catalyst tube or a group of catalyst tubes (K1, K2, K3) of a steam reformer (R), wherein each of said at least two feed mixtures (6, 9) is converted into a synthesis gas (10, 11), whereby at least two synthesis gases (10, 11) having different compositions are formed.

2. The process according to claim 1, wherein each of the synthesis gases (10, 11) formed is subsequently further treated independently of the other synthesis gas or other synthesis gases.

3. The process according to claim 1, wherein natural gas is used as hydrocarbon-containing starting material (1).

4. The process according to claim 1, wherein liquefied petroleum gas is used as hydrocarbon-containing starting material (1).

5. The process according to claim 1, wherein naphtha is used as hydrocarbon-containing starting material (1).

6. The process according to claim 1, wherein refinery gas is used as hydrocarbon-containing starting material (1).

7. The process according to claim 2, wherein natural gas is used as hydrocarbon-containing starting material (1).

8. The process according to claim 2, wherein liquefied petroleum gas is used as hydrocarbon-containing starting material (1).

9. The process according to claim 2, wherein naphtha is used as hydrocarbon-containing starting material (1).

10. The process according to claim 2, wherein refinery gas is used as hydrocarbon-containing starting material (1).

11. A process for the parallel production of at least two synthesis gases (10, 11) having different compositions from a hydrocarbon-containing starting material (1) which is, after mixing with steam (2) and/or carbon dioxide (3), fed to a steam reformer (R) and there converted into synthesis gas by steam reforming in at least two catalyst tubes (K1, K2, K3) operated in parallel, characterized in that at least two mixtures (6, 9) having different compositions are formed from the hydrocarbon-containing starting material (1) by division and addition of steam (2) and/or carbon dioxide (3), where each of the different mixtures (6, 9) is fed as exclusive feed to a catalyst tube or a group of catalyst tubes (K1, K2, K3) of the steam reformer (R) and converted into synthesis gas (10, 11).

12. An apparatus for the parallel production of at least two synthesis gases (10, 11) having different compositions from a hydrocarbon-containing starting material (1), said apparatus comprising:
a steam reformer (R) having a firing chamber (F) and at least a first catalyst tube and a second catalyst tube (K1, K2, K3), and
a device (mixing system) (M), for mixing of steam (2) and/or carbon dioxide (3) into a hydrocarbon-containing starting material (1), which is connected to the catalyst tubes (K1, K2, K3),
wherein at least a first mixture (6) and a second mixture (9) having different compositions, of which the first mixture (6) can be fed as exclusive feed to the first catalyst tube (K1, K2) and the second mixture (9) can be fed as exclusive feed to the second catalyst tube (K3), are producible in the mixing system (M) from a hydrocarbon-containing starting material (1).

13. The apparatus according to claim 12, wherein the catalyst tubes (K1, K2, K3) are structurally identical and are arranged in the same firing chamber (F) of said steam reformer (F).

14. The apparatus according to claim 12, wherein said mixing system (M) is connected via a distributor (V1, V2) to the entry ends of a plurality of catalyst tubes (K1, K2, K3) so that a mixture (8, 9) produced in the mixing system (M) can be distributed as exclusive feed over a group of catalyst tubes.

15. The apparatus according to claim 14, wherein the catalyst tubes connected via the distributor (V1, V2) are arranged in one or more preferably parallel and adjacent rows (D1, D2, D3) of tubes.

16. The apparatus according to claim 12, wherein outlet ends of the catalyst tubes (K1, K2, K3), over which a mixture (6, 9) produced in the mixing system (M) can be distributed, are connected to one another via a collector (S1, S2) via which exclusively the synthesis gas (10, 11) which is producible in these catalyst tubes can be collected and discharged.

17. The apparatus according to claim 12, wherein catalyst tubes (K1, K2, K3) arranged in the steam reformer are all identical.

18. The apparatus according to claim 12, wherein catalyst tubes (K1, K2, K3) arranged in the steam reformer differ in respect of their dimensions and/or their structure and/or the type and/or amount of the catalyst material present therein.
